(19) United States
(12) Patent Application Publication
(10) Pub. No.: US 2014/0170622 A1
(43) Pub. Date: Jun. 19, 2014

(54) Training Pad Connector

(71) Applicants: John J. Pastrick, University Heights, OH (US); Timothy E. Lint, North Royalton, OH (US); Mark E. Cook, Stow, OH (US)

(72) Inventors: John J. Pastrick, University Heights, OH (US); Timothy E. Lint, North Royalton, OH (US); Mark E. Cook, Stow, OH (US)

(21) Appl. No.: 14/024,447

(22) Filed: Sep. 11, 2013

Related U.S. Application Data
(60) Provisional application No. 61/699,572, filed on Sep. 11, 2012.

(51) Int. Cl. G09B 23/28

(52) U.S. Cl. CPC G09B 23/288
USPC 434/265

(57) ABSTRACT

An improved training pad connector device for connecting a disposable electrode training pad to an electrical cable using a very low profile, approximately 0.16 of an inch, which does not interrupt the external surface or dimensions of the training pad. The connector includes a top piece and a bottom piece forming a unitary body for capturing the electrical contacts and extending cable between the interconnected top and bottom pieces, and for engaging the electrode training pad on an extending tab. The top and bottom pieces of the connector and the electrode training pad each include aligned openings for receiving a removable pin. The removable pin engages the connector in an interference fit to secure the pad and connector together.

This application claims the benefit of U.S. Provisional Application No. 61/699,572, filed Sep. 11, 2012, and U.S. patent application Ser. No. 13/352,319, filed Jan. 17, 2012, the entireties of each are incorporated herein by reference.

### FIELD OF INVENTION

The present application provides an improved automatic external defibrillator (AED) training pad connector for electrically connecting an AED training device to training pads.

### BACKGROUND

AED and cardiopulmonary resuscitation (CPR) training devices and are well known in the art. For example, as set forth in U.S. Pat. Nos. 6,969,259 and 6,872,080, AED-CPR training devices, training pads, and a cable and connector for electrically connecting the device and pads, are shown. The disadvantages of such prior art training pad connectors are that they are somewhat expensive to manufacture. The profile of such prior art connectors with respect to the surface of the pad, although fairly low, is not as low as is desired during AED compression and/or CPR training. It is very desirable during training that the training pads and connectors are as close to the same height as possible (or have a very low profile), so that the application of the student's hands to the pad is comfortable during compression training. Additionally, connectors and pads must be very easily attached together and separated, since replacement pads are often required to be installed on original equipment cables during or prior to training sessions using such devices.

### SUMMARY OF THE INVENTION

The improved training pad connector device is used to connect a disposable electrode training pad to an electrical cable for use with an AED training device, and provides a very low profile connector which does not interrupt the external surface or dimensions of the training pad. The connector includes a top piece and a bottom piece forming a unitary body. The top and bottom pieces each have an aligned opening, and capture the electrical contacts and extending cable between the interconnected top and bottom pieces. An electronic circuit board, electrically printed on thin film polyester, is positioned within the bottom piece of the connector for engagement with the electrical contacts of the cable and for engagement with electrical contacts on the disposable electrode training pad.

The training pad is a foam pad with an extending tab also having an opening for alignment with the openings in the top and bottom pieces of the connector. The foam pad has a thickness of approximately 1/16 of an inch. The thin or low profile of the pad and interconnected connector are together approximately 0.16 of an inch, which enables the training pad to remain in a flat, horizontal position, and outside the compression surface of the training pad in order to avoid interference with the student's hands during training.

A removable pin is provided to secure the pad and connector together, which pin is engaged through the aligned openings, and provides an interference fit with the connector. These and other features and advantages of the present connector will become apparent in the detailed description and claims that follow, taken in conjunction with the accompanying drawings.

### BRIEF DESCRIPTION OF THE DRAWINGS

FIG. 1 illustrates a perspective top view of a disposable electrode training pad with the training pad connector and cable attached, and a perspective bottom view of the electrode training pad without the connector or cable and showing the conductive circuit on the bottom surface of the pad for generating a signal to an AED-CPR device when the training pad is properly connected to the connector and placed by a student within the proper location on a conductive target of a simulated victim's chest for defibrillation;

FIG. 2 illustrates an enlarged perspective view of the improved training pad connector device installed on the electrode training pad;

FIG. 3 illustrates a perspective top view of a training pad connector removed from a training pad, and a perspective bottom view of a pin being removed from engagement with the connector;

FIGS. 4 and 5 illustrate the positioning of the training pad and training pad connector prior to and after sliding the training pad into engagement with the training pad connector, respectively;

FIG. 6 illustrates an exploded view of the pin, top and bottom pieces of the connector and an adjacent electrode training pad;

FIG. 7 illustrates an inverted exploded view of the components in FIG. 6, with the bottom piece, top piece and pin of the training pad connector shown adjacent the bottom view of the adjacent electrode training pad;

FIG. 8 is a schematic, cut-away view of the training pad connector, showing the electrode training pad and connector in aligned position, with the flat surfaces in the diameter of the opening in the top piece of the training pad connector being readily apparent;

FIG. 9 is a schematic, cut-away view of the training pad connector and pin engaged, showing the interference fit of the top piece of the connector with the hollow body portion of the pin; and

FIG. 10 is an enlarged schematic, cut-away view of the connector and pin engaged as in FIG. 9, but with the top piece of the connector shown as a line, to demonstrate the interference fit where the top piece of the connector is engaged into the hollow body portion of the pin.

### DETAILED DESCRIPTION

In the present AED training pad connector device 12, a cable or electrical cable 14 is provided to interconnect an AED training device with a disposable electrode training pad 16. At one end of the electrical cable 14 is a plug end for electrical connection with a plug receptacle on the AED training device (not shown). The plug must be properly electrically interconnected with the training device or the student will be required to correct the connection prior to proceeding with any training.

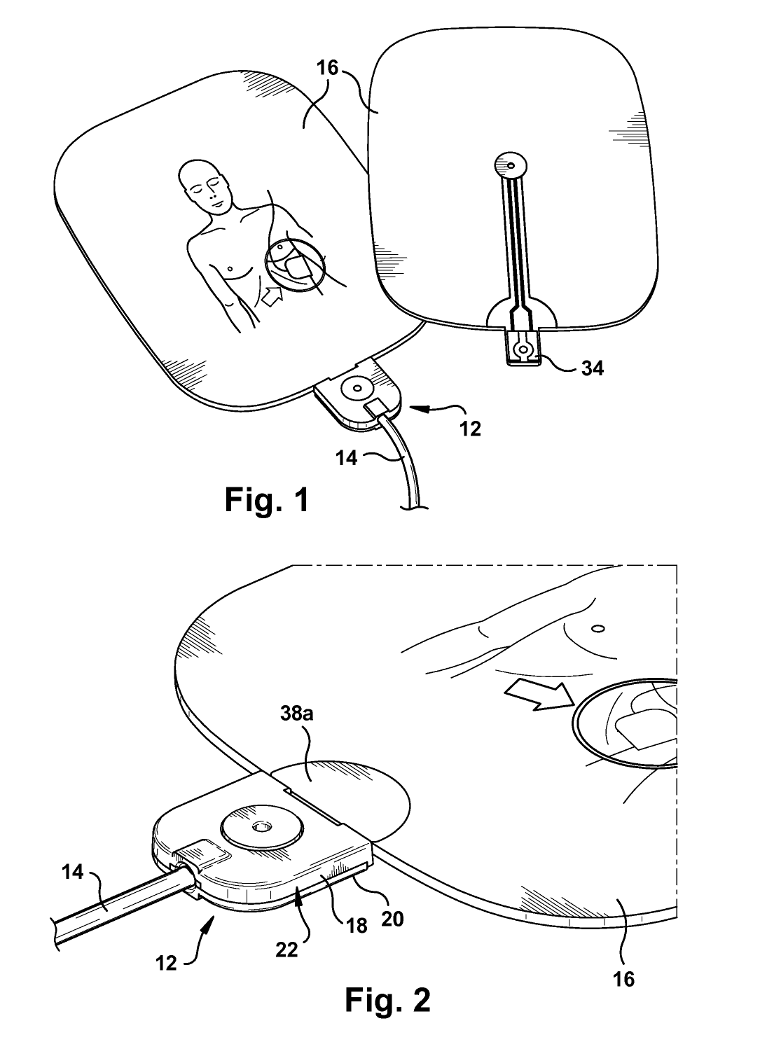

At the opposite end of the cable 14, the disposable electrode training pad 16 is interconnected with the cable 14 via a training pad connector 16, as shown in FIGS. 1-2. The disposable electrode training pads 16 are simulated defibrillator pads, which pads are used on patients during treatment with an AED device. The disposable electrode training pads 16 are to be connected to or inserted into the training pad connector 12, as shown in FIGS. 4 and 5. Once connected, the disposable electrode training pads 16 are to be secured by the student on a simulated victim's chest or training manikin.

The improved training pad connector device 12 used to connect the disposable electrode training pads 16 to the cable 14 provides a very low profile device, which does not interrupt the external surface or dimensions of the training pads 16. The connector 12 of this application includes a top piece 18 and a bottom piece 20 forming a unitary body 22. The top and bottom pieces each have an aligned opening 24, 26, respectively, and the pieces are preferably sonically welded together along raised polymer peaks 28 on the top piece, to capture the electrical contacts 30 and extending cable 14 between the interconnected top and bottom pieces 18, 20. Additionally, an electronic circuit board 32, electrically printed on thin film polyester, is positioned within the bottom piece 20 of the connector 12 for engagement with the electrical contacts 30 of the cable 14 and for engagement with electrical contacts 34 on the disposable electrode training pad 16. The connector top and bottom pieces 18, 20 may be of any of numerous appropriate polymer materials which may be sonically welded, as well as sufficient to insulate the electrical contacts and circuit boards.

The training pad 16 also has an opening 40 for alignment with the openings 24, 26 in the top and bottom pieces 18, 20 of the connector 12. The training pad 16 is preferably a die cut foam pad having a tab 38 with the opening 40 for engagement into the connector 12. The foam may be of any desirable material, but preferably is a pad having a thickness of approximately 1/16 of an inch. Although not required, one or both sides of the tab 38 of the foam pad, and a small semi-circular area 38a extending into the pad, may have a thin film polyester layer of 0.05 inches thick, which is adhered to the pad in order to provide easy insertion of the pad into the connector. In addition to easing insertion of the tab 38 into the connector 12, the thin film polyester adds tensile strength to the foam (especially the hole area which surrounds the pin), which by itself can often tear relatively easily. The thin or low profile of the pad 16 and connector 12, approximately 0.16 of an inch in height, of this application are an important aspect of the invention. For successful compressions by the student on the simulated victim's chest supporting the electrode pads 16, the compression surface of the training pad needs to be flat in order to avoid interference with the student's hands during training. A low profile connector adjacent the compression surface of the training pad ensures the horizontal position of the training pad 16, and avoidance of interference with the student's training.

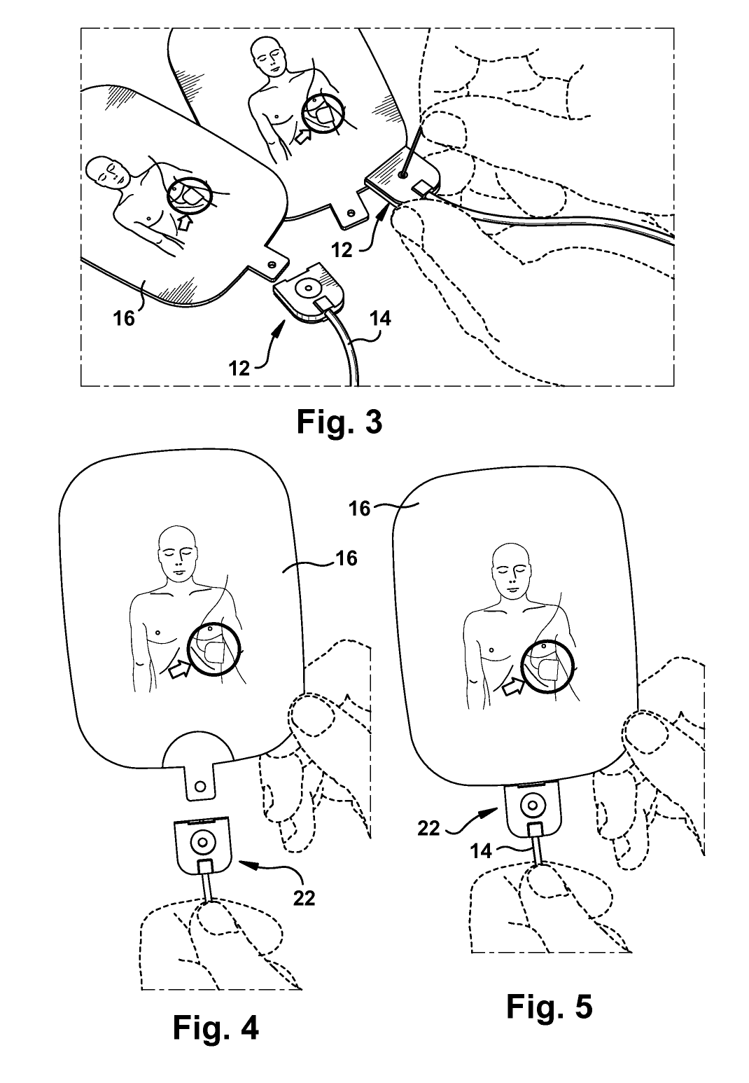

To secure the tab 38 of the foam pad 16 within the connector 12, a removable pin 50 is provided and is engaged through each of the 3 aligned openings 24, 26, 40 when the tab 38 of the foam pad is slidably engaged within the interconnected unitary body 22 of the connector 12. The pin 50 includes a head portion 52 and a body portion 54. Insertion of the pin body portion 54 into the 3 aligned openings, is similar to pushing a thumb tack into a cork board. To remove the pin 50, any small pointed implement may be used to pop it out of the openings, such as the end of a paper clip or the tip of an ink pen, as shown in FIG. 3. The feature of popping out the pin 50 eliminates the need for any kind of latch or other fastener to remove the pin which would generally need to protrude from the connector to be accessible, and therefore could also cause discomfort under a student's hands during compression training.

The removable pin 50 provides an interference fit with the connector 12. When installed, the body portion 54 of the removable pin 50 passes through the connector top piece 18, the foam pad 16 and the connector bottom piece 20, and provides a snap in connection. The force used to install the pin 50 provides a 100% mechanical advantage to resist removal, either under forces of the pieces themselves, or by external factors. The top piece 18 of the connector 12 has a recessed area 19 to receive the head portion 52 of the pin, and further ensure the low profile of the pin 50 within the connector. The substantially round external diameter 58 of the pin body 50 engages the internal diameter 25 of the opening 24 of the top piece 18 of the connector with an interference fit.

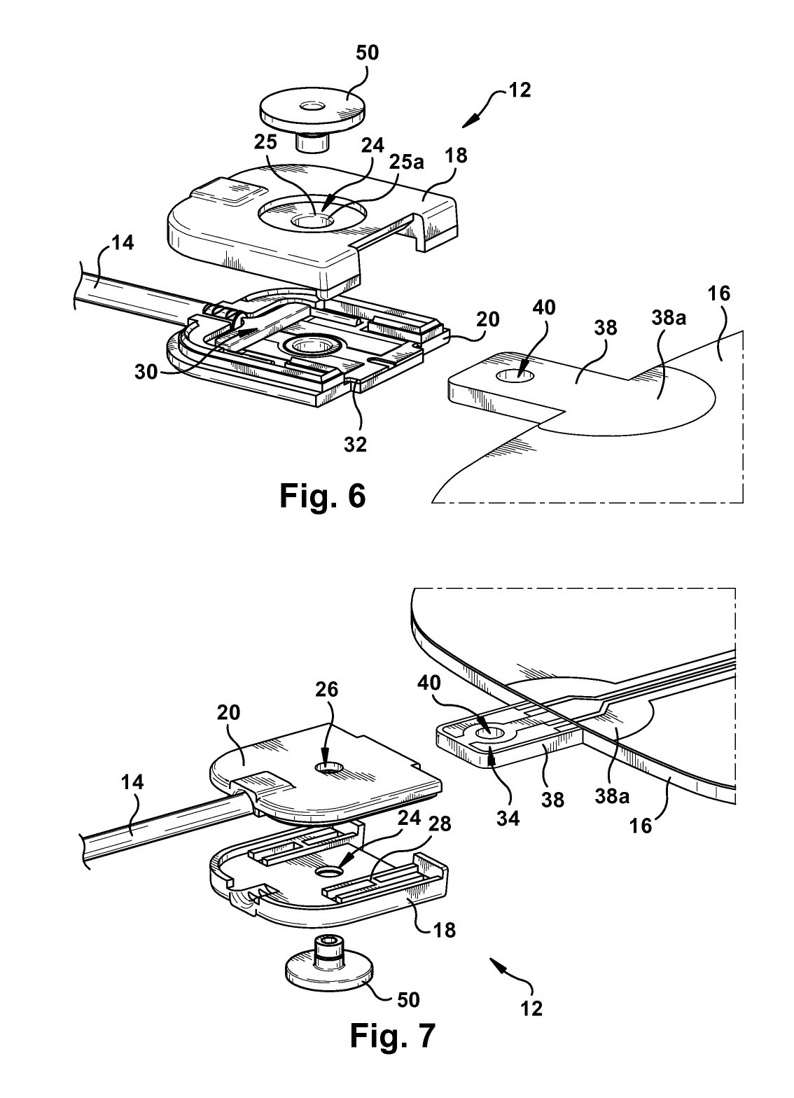

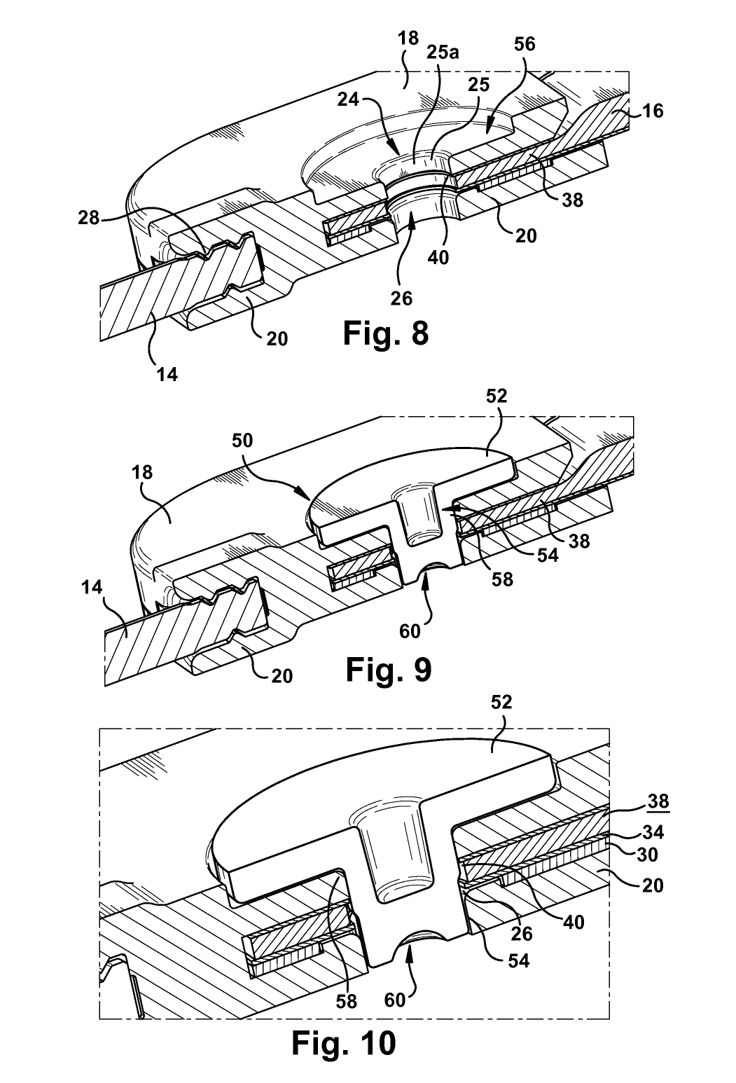

The snap connection of the pin 50 within the connector 12 is provided by the shape of the internal diameter 25 of the top piece opening 24 of the connector, which is not round, but has squared or flat surfaces 25a on at least 2 or more sides, or preferably to opposing sides or 180 degrees (but also 90 or 120 degrees) from each other, to engage the pin. The flats or squared configuration of the internal diameter 25 of the top piece opening 24 of the connector 12 is shown in FIGS. 6 and 8-10. It should be understood that 2 flat surfaces on the top piece opening 24 provides sufficient non-crushing engagement, which distorts the pin body and maintains its engagement with the top piece. The use of at least 2 flat surfaces 25a makes the improved connector 12 less sensitive to variation and allows the material of the pin 50, which may be any number of desirable flexible polymers, more space to move. It should be understood that the interference fit between the pin 50 and top piece 18 of the connector may be provided by any appropriate interference fit relationship.

Also, the portion of the pin or pin body 54 which engages the top piece 18 of the connector 12 is hollow and has an open top, as shown in FIGS. 9-10, which further enables interference engagement of the pin with the top piece of the connector. Generally, the interference engagement provided between the hollow pin body and the opening of the top piece enables elastic distortion of the pin body, for example, with 2 flat surfaces, the pin body distorts to an elliptical shape. This configuration enables elastic distortion of the pin without any permanent distortion of the material of the pin body, thus enabling repeated insertion and removal of the pin without any meaningful change in the holding force performance of the pin. The remainder of the pin body below the hollow section is solid. However, the lower portion of the pin body 54 which is positioned within the bottom portion 20 of the connector once installed has a slightly smaller external diameter, which may be angled, such that it does not contact or engage the bottom piece 20 of the connector. A still further slightly reduced diameter at the end of the pin body 54 assists with insertion of the pin 50 into the aligned openings 24, 26, 40. A dimple or recess 60 is also provided in the end of the pin body 54, in order to assist with placement of a pointed tool during removal of the pin. The opening in the foam pad 40 does not engage the pin body 54 due to the size of the external diameter 58 of the pin and the foam pad opening 40. Thus, the pin 50 of the present application passes through two layers of the connector 12, engages only the top piece 18 of the connector, and captures the foam pad tab 38 intermediate the top and bottom connector pieces 18, 20. The foam pad is compressed inside the clip or connector 12 so that the resulting pressure insures electrical contact between the connector electrical leads 30 and circuit board 32 and the electrical connections 34 on the electrode pad 16. There is no bending of the foam or the connector, to enable the forces to be properly balanced for enhanced performance.

While the preferred embodiments of the invention have been illustrated and described, it should be understood that variations will become apparent to those skilled in the art. Accordingly, the device is not limited to the specific embodiments illustrated and described herein, but rather the true scope and spirit of the invention are to be determined by reference to the appended claims.

1. A training pad connector having a top piece secured to a bottom piece and a removable pin for providing an interference fit with the top piece of the connector to connect a training pad inserted into the connector.

2. An electrode training pad connector having a top piece, a bottom piece and a removable pin for providing an interference fit with the top piece of the connector to electrically connect an electrode training pad to the connector.

3. The electrode training pad connector of claim 2, wherein the removable pin has a partially hollow body portion.

4. The electrode training pad connector of claim 2, wherein the removable pin has a substantially round external dimension, the bottom piece and the electrode training pad each have an opening for aligned engagement by the removable pin, and the top piece has an opening with at least 2 partially flat internal surfaces for aligned interference engagement with the removable pin.

5. A training pad connector having a body supporting electrical circuitry, an electrical cable, an electrode training pad, and having a pin engaging the body with an interference fit for electrically interconnecting the electrode training pad with the electrical circuitry and cable.

6. A training pad connector for connecting a disposable electrode training pad to an electrical cable, the connector and interconnected disposable electrode training pad having a very low profile, approximately 0.16 of an inch, which does not interrupt the external surface or dimensions of the disposable electrode training pad.
